(19) United States
(12) Patent Application Publication
(10) Pub. No.: US 2025/0276297 A1
(43) Pub. Date: Sep. 4, 2025

(54) BLENDING APPARATUS

(71) Applicant: LEEDARSON LIGHTING CO.,LTD., Zhangzhou (CN)

(72) Inventors: Jiadong Chen, Zhangzhou (CN); Xiaoping Li, Zhangzhou (CN); Zhongtao Luo, Zhangzhou (CN); Tao Wang, Zhangzhou (CN)

(21) Appl. No.: 18/949,965

(22) Filed: Nov. 15, 2024

(30) Foreign Application Priority Data
Mar. 4, 2024 (CN) 202420413015.X

(51) Int. Cl. B01F 35/00; B01F 27/09; B01F 27/808; B01F 27/906; B01F 33/501; B01F 35/11; B01F 35/32; B01F 35/50; B01F 35/60; B01F 35/90; B01F 35/95; B01F 101/00

(52) U.S. Cl. CPC B01F 35/56; B01F 27/09; B01F 27/808; B01F 27/906; B01F 33/501; B01F 35/11; B01F 35/32025; B01F 35/50; B01F 35/6052; B01F 35/95; B01F 2035/99; B01F 2101/1805

(57) ABSTRACT

A blender apparatus includes a cup cover, a bottom cover, a cup body and a blade assembly. The cup body includes an inner cavity. The cup body includes a first port above the inner cavity. The cup body includes a second port below the inner cavity. The first port is detachably connected to the cup cover. The blade assembly includes a blade and a motor and a blade housing. The blade assembly includes an operation state and a storage state. In the operation state, the blade of the blade assembly is inserted into the inner cavity through the second port of the cup body for cutting and mixing objects placed in the inner cavity.

### FIELD

The present invention is related to a blender apparatus, and more particularly related to a blender apparatus with compact size.

### BACKGROUND

Juicer machines and blender machines have become staples in modern kitchens, offering convenience and health benefits that appeal to households around the world. These machines simplify the process of making fresh juices, smoothies, and other nutritious beverages, allowing users to incorporate fruits and vegetables into their diets effortlessly. One of the key reasons people love juicer machines is their ability to extract pure juice from fruits and vegetables, leaving behind pulp. This feature caters to those who prefer a smooth and refreshing drink without fiber. Juicers are especially appreciated by health-conscious individuals seeking to increase their intake of vitamins and minerals in a natural and tasty way.

Blender machines, on the other hand, are beloved for their versatility. They can blend, puree, and mix a wide range of ingredients, making them ideal for creating smoothies, soups, sauces, and even batters. The ability to retain the fiber from fruits and vegetables in blended drinks is a significant advantage for those aiming to maintain a balanced diet. The design of these machines also plays a big role in their popularity. Both juicers and blenders are available in various sizes, colors, and styles, allowing consumers to choose one that matches their kitchen aesthetics while meeting their functional needs.

Despite their usefulness, these machines are generally designed for home use and are not very portable. The size and weight of standard juicers and blenders make them impractical to carry around, limiting their usability to the home environment. Even compact models, while smaller, often lack the power and capacity of their full-sized counterparts, making them less versatile. For those seeking portability, there are mini juicers and blenders designed for travel or on-the-go use, but these typically have smaller cups and lower power due to the constraints of their design.

The smaller cup size of portable machines can be a drawback for users who want to make larger servings. Portable juicers and blenders are often designed with a single-serving capacity, which may not be sufficient for families or those preparing beverages for multiple people. However, these machines are highly appreciated by individuals with busy lifestyles who value the ability to prepare fresh drinks quickly and conveniently, whether at work, the gym, or on a trip.

Another reason people love these products is their ability to enhance health and wellness routines. Juicers are perfect for creating detox drinks and cleansing programs, while blenders are great for making protein shakes and meal replacements. This dual capability of offering health benefits and convenience has contributed significantly to the growing demand for such appliances. The availability of advanced features, such as preset programs, touch controls, and self-cleaning options, has further increased the appeal of juicer and blender machines.

Many users also enjoy experimenting with recipes and ingredients, turning their kitchens into creative spaces. Juicers allow them to create unique juice blends, while blenders enable the preparation of everything from fruit smoothies to frozen desserts. This flexibility inspires culinary exploration, making these machines an essential part of many households. The robust construction of high-quality machines also ensures that they can handle tough ingredients like nuts and ice, which expands their functionality even further.

However, the limitations of portable models often require users to compromise. While portable machines are convenient, they lack the capacity and power to handle heavy-duty tasks or large quantities. This trade-off between portability and functionality is a key factor for consumers when choosing between standard and portable machines. For those who prioritize convenience over capacity, portable machines are a worthy choice, but they cannot entirely replace full-sized models for more demanding tasks.

The rising trend of minimalistic and mobile lifestyles has driven innovation in portable machine designs, making them more compact and easier to carry. Some models are battery-operated, removing the need for a power outlet and allowing users to prepare fresh beverages wherever they go. Despite these advancements, the smaller size and limited power of portable machines mean they are better suited for light tasks, such as blending soft fruits or making simple juices, rather than heavy-duty blending or juicing.

Overall, the love for juicer and blender machines stems from their ability to simplify healthy living while offering versatility and convenience. These machines have earned a special place in homes, helping individuals lead healthier lives and explore new culinary possibilities. Although their portability is limited, the introduction of smaller, portable models has ensured that they cater to a wider range of needs, from home use to on-the-go lifestyles.

### SUMMARY

In some embodiments, a blender apparatus includes a cup cover, a bottom cover, a cup body and a blade assembly.

The cup body includes an inner cavity.

The cup body includes a first port above the inner cavity.

The cup body includes a second port below the inner cavity.

The first port is detachably connected to the cup cover.

The blade assembly includes a blade and a motor and a blade housing.

The blade housing encloses the blade housing and exposes the blade.

A bottom end of the blade housing is attached to the bottom cover in an operation state.

The blade assembly includes an operation state and a storage state.

In the operation state, the blade of the blade assembly is inserted into the inner cavity through the second port of the cup body for cutting and mixing objects placed in the inner cavity.

In the storage state, the blade of the blade assembly is inserted into the inner cavity through the first port of the cup body.

In the storage state, the bottom cover is connected to the second port of the cup body.

In some embodiments, the blade is exposed on a top end of the blade housing.

The motor drives the blade to rotate inside the inner cavity of the cup body in the operation mode.

In some embodiments, a connection between the bottom cover and the bottom end of the blade housing, and the connection between the bottom cover and the second port are both threaded connections.

In some embodiments, the bottom cover includes a first internal thread on an inner circumferential wall of the bottom cover.

The bottom end of the blade assembly includes a first external thread.

The second port includes a second external thread.

In the operation state, the first internal thread is connected to the first external thread.

In the storage state, the first internal thread is connected to the second external thread.

In some embodiments, the cup body includes a straight tubular portion and a conical tubular portion.

One end of the straight tubular portion is the first port.

A large diameter end of the conical tubular portion is connected to another end of the straight tubular portion.

An inner diameter of the large diameter end equals to an inner diameter of the straight tubular portion.

A small diameter end of the conical tubular portion is the second port.

The inner diameter of the straight tubular portion is greater than an outer diameter of the blade assembly.

In some embodiments, the cup cover includes a main cover body and a flip cover.

The main cover body is threadedly connected to the first port.

The main cover body includes a pouring port.

One end of the flip cover is hinged to the main cover body.

Another end of the flip cover is snap-fitted with an outer wall of the main cover body.

The flip cover is used for sealing the pouring port.

In some embodiments, the cup cover includes a handle rotatably connected to the cup cover.

In some embodiments, the blender apparatus may also include a safety switch.

When the top end of the blade housing is attached to the second port of the cup body, the safety switch activates the motor.

When the motor is not activated by the safety switch, the motor stops to work.

In some embodiments, the blender apparatus may also include a safety switch.

When the blade is inserted into the internal cavity, the safety switch is activated to deactivate the motor.

In some embodiments, the blade assembly further includes a blade cover.

The blade cover covers the blade.

The blade cover is detachable from the blade assembly.

In some embodiments, an auxiliary blade is disposed on an opposite side of the blade housing with respect to the blade.

In some embodiments, the blade or the auxiliary blade is selected to be inserted into the inner cavity of the cup body.

In some embodiments, the blade assembly further including a heater for generating heat passed through the blade to the objects inside the inner cavity of the cup body.

In some embodiments, the blade assembly further includes a battery for supplying power to the motor.

In some embodiments, the blade assembly further including a fan disposed on the opposite side of the blade housing.

The blade and the fan share the motor.

In some embodiments, the blade assembly further including an ultrasonic cleaner module.

The ultrasonic cleaner module cleans the internal cavity of the cup body when users load the internal cavity with clean water.

In some embodiments, the ultrasonic cleaner module share the motor with the blade.

In some embodiments, where a vibrating unit of the ultrasonic cleaner module is mounted on the blade.

In some embodiments, the ultrasound cleaner module is activated when the blade is cutting and blending the objects in an ultra blending mode.

In some embodiments, the blade assembly further includes a flow guiding module.

The flow guiding module creates a liquid low in the internal cavity of the cup body in the operation mode.

### BRIEF DESCRIPTION OF DRAWINGS

FIG. 1 illustrates is an exploded structural diagram of the juicer provided by the embodiment of the embodiment.

FIG. 2 illustrates is a structural diagram of the juicer provided by the embodiment of the embodiment in its usage state.

FIG. 3 illustrates is a partial exploded structural diagram of the juicer provided by the embodiment of the embodiment in its storage state.

FIG. 4 illustrates is a structural diagram of the cup body of the juicer provided by the embodiment of the embodiment.

FIG. 5 illustrates is a structural diagram of the bottom cover of the juicer provided by the embodiment of the embodiment.

FIG. 6 illustrates is an exploded structural diagram of the blade assembly of the juicer provided by the embodiment of the embodiment.

FIG. 7 illustrates is a structural diagram of the lid of the juicer provided by the embodiment of the embodiment.

FIG. 8 illustrates another embodiment.

FIG. 9 shows an operation mode of the embodiment in FIG. 8.

FIG. 10 shows a storage mode of the embodiment in FIG. 8.

FIG. 11 shows another blade assembly.

### DETAILED DESCRIPTION

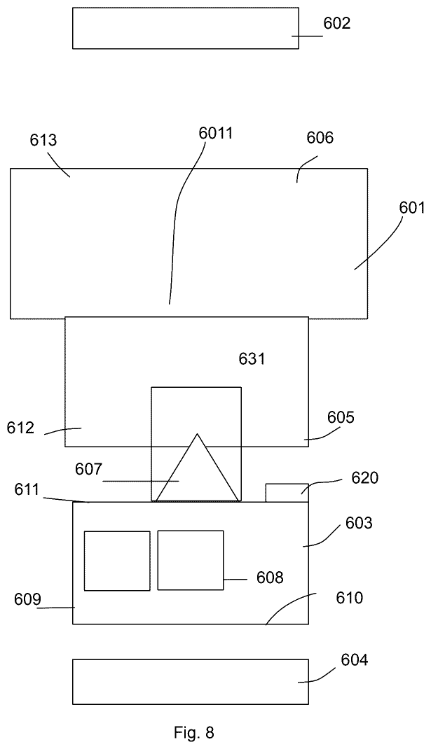

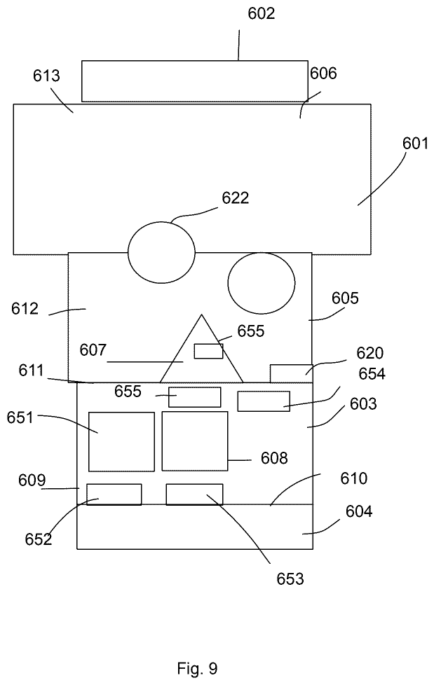

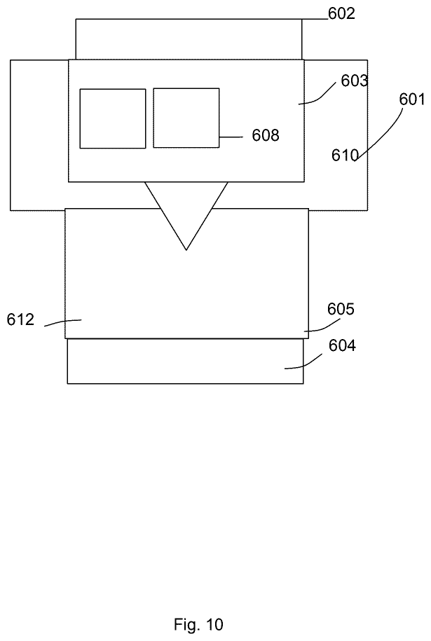

FIG. 8 illustrates a blender apparatus embodiment. FIG. 9 shows an operation mode of the embodiment in FIG. 8. FIG. 10 shows a storage mode of the embodiment in FIG. 8. Please refer to the third drawings at the same time with explanation of following description.

In FIG. 8, FIG. 9 and FIG. 10, a blender apparatus includes a cup cover 602, a bottom cover 604, a cup body 601 and a blade assembly 603.

The cup body 601 includes an inner cavity 6011.

The cup body 601 includes a first port 606 above the inner cavity 6011.

The cup body 602 includes a second port 605 below the inner cavity 6011.

The first port 606 is detachably connected to the cup cover 602.

The blade assembly 603 includes a blade 607 and a motor 608 and a blade housing 609.

The blade housing 603 encloses the blade housing 609 and exposes the blade 607.

A bottom end 610 of the blade housing 609 is attached to the bottom cover 604 in an operation state. FIG. 9 shows the operation state while FIG. 8 shows an exploded diagram.

The blade assembly 603 includes an operation state and a storage state.

In the operation state, the blade 607 of the blade assembly 603 is inserted into the inner cavity 6011 through the second port 605 of the cup body 601 for cutting and mixing objects 622 placed in the inner cavity 6011.

In the storage state, the blade 607 of the blade assembly 603 is inserted into the inner cavity 6011 through the first port of the cup body 601. FIG. 10 shows such mode.

In the storage state, the bottom cover is connected to the second port of the cup body.

In some embodiments, the blade is exposed on a top end of the blade housing.

The motor drives the blade to rotate inside the inner cavity of the cup body in the operation mode.

In some embodiments, a connection between the bottom cover and the bottom end of the blade housing, and the connection between the bottom cover and the second port are both threaded connections.

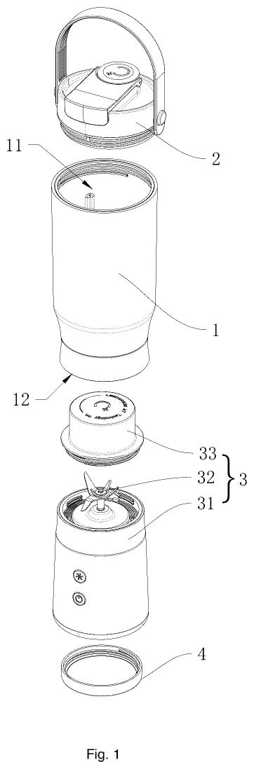

The examples in FIG. 1 to FIG. 7 show such threaded connection.

In some embodiments, the bottom cover includes a first internal thread on an inner circumferential wall of the bottom cover.

The bottom end of the blade assembly includes a first external thread.

The second port includes a second external thread.

In the operation state, the first internal thread is connected to the first external thread.

In the storage state, the first internal thread is connected to the second external thread.

In some embodiments, the cup body includes a straight tubular portion and a conical tubular portion.

One end of the straight tubular portion is the first port.

A large diameter end of the conical tubular portion is connected to another end of the straight tubular portion.

An inner diameter of the large diameter end equals to an inner diameter of the straight tubular portion.

A small diameter end of the conical tubular portion is the second port.

The inner diameter of the straight tubular portion is greater than an outer diameter of the blade assembly.

In some embodiments, the cup cover includes a main cover body and a flip cover.

The main cover body is threadedly connected to the first port.

The main cover body includes a pouring port.

One end of the flip cover is hinged to the main cover body.

Another end of the flip cover is snap-fitted with an outer wall of the main cover body.

The flip cover is used for sealing the pouring port.

In some embodiments, the cup cover includes a handle rotatably connected to the cup cover.

In some embodiments, the blender apparatus may also include a safety switch.

When the top end of the blade housing is attached to the second port of the cup body, the safety switch activates the motor.

When the motor is not activated by the safety switch, the motor stops to work.

In FIG. 8, the blender apparatus may also include a safety switch 620.

When the blade is inserted into the internal cavity, the safety switch 620 is activated to deactivate the motor. For example, a mechanic button that activates or deactivate the motor when the button is pressed by connecting the blade assembly to the cup body.

In some embodiments, the blade assembly further includes a blade cover 631.

The blade cover 631 covers the blade 607.

The blade cover is detachable from the blade assembly.

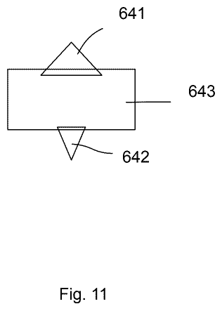

In FIG. 11, an auxiliary blade 642 is disposed on an opposite side of the blade housing 643 with respect to the blade 641.

In some embodiments, the blade or the auxiliary blade is selected to be inserted into the inner cavity of the cup body.

In FIG. 9, the blade assembly further including a heater 651 for generating heat passed through the blade to the objects inside the inner cavity of the cup body.

A heater module integrated into a blending system can significantly enhance its functionality by providing the ability to heat the contents during blending. This dual-action capability is particularly valuable for preparing recipes that require precise temperature control, such as soups, sauces, or heated beverages. By combining blending and heating in a single device, the heater module eliminates the need for separate appliances, streamlining the cooking process and saving time.

When blending ingredients like soybeans to make soy milk, the heater module can maintain or raise the temperature of the liquid to a desired level during the blending process. This ensures that the soy milk achieves the optimal consistency and flavor, as heating plays a crucial role in breaking down proteins and enhancing the natural sweetness of the beans. The continuous application of heat while blending also ensures uniform cooking, preventing uneven heating or cold spots within the mixture.

Additionally, the integration of a heater module opens up new possibilities for innovative food preparation. For example, it allows users to create ready-to-serve hot soups directly in the blender without transferring the mixture to a separate pot for cooking. This convenience not only simplifies meal preparation but also reduces cleanup, making the blending device a versatile and efficient tool in the kitchen. The ability to heat while blending enhances the appliance's appeal to users seeking multi-functional solutions for their culinary needs.

In FIG. 9, the blade assembly further includes a battery 652 for supplying power to the motor.

In FIG. 9, the blade assembly further including a fan 653 disposed on the opposite side of the blade housing.

The blade 607 and the fan 653 share the motor.

In FIG. 9, the blade assembly further including an ultrasonic cleaner module 654.

The ultrasonic cleaner module cleans the internal cavity of the cup body when users load the internal cavity with clean water.

Integrating an ultrasonic cleaner module into a blender significantly improves the ease and efficiency of cleaning its internal cavity, addressing a common challenge faced by users. The intricate design of blender jars, with sharp blades and hard-to-reach corners, often makes thorough cleaning difficult. Ultrasonic cleaning technology generates high-frequency sound waves in a cleaning liquid, producing microscopic cavitation bubbles. These bubbles implode rapidly, creating a scrubbing action that can reach areas conventional cleaning methods often miss.

The ultrasonic cleaner module works seamlessly with the blender by targeting stubborn residues that tend to accumulate around the blades and at the base of the jar. Food particles, grease, and other contaminants are dislodged and removed effectively without the need for manual scrubbing. This gentle yet thorough cleaning process ensures that the blender remains hygienic and ready for its next use, particularly important when blending foods that can leave strong odors or stains, such as garlic, turmeric, or leafy greens.

Adding an ultrasonic cleaning feature not only enhances user convenience but also extends the blender's lifespan by reducing wear from abrasive cleaning methods. It minimizes the risk of accidental damage to the blades or jar during cleaning, preserving the appliance's performance over time. This innovation transforms the blender into a more versatile and user-friendly device, appealing to those who value both functionality and ease of maintenance in their kitchen tools.

In some embodiments, the ultrasonic cleaner module share the motor with the blade.

In FIG. 9, where a vibrating unit 655 of the ultrasonic cleaner module is mounted on the blade 607.

In some embodiments, the ultrasound cleaner module is activated when the blade is cutting and blending the objects in an ultra blending mode.

Incorporating ultrasound technology into the blending process introduces an innovative way to enhance the flavor and texture of blended liquids, such as juices and smoothies. Ultrasound waves create rapid vibrations and microscopic cavitation bubbles within the liquid, which can break down fruit and vegetable cells more effectively than conventional blending alone. This process releases more natural flavors, sugars, and nutrients, resulting in a richer and more intense taste profile.

The use of ultrasound during blending also helps to create a smoother and more uniform consistency in liquids. By reducing the size of suspended particles and breaking down fibrous components, the ultrasonic vibrations eliminate graininess and improve the mouthfeel of the juice. This is particularly beneficial for drinks made with high-fiber ingredients like carrots, beets, or leafy greens, as the enhanced breakdown ensures a more pleasant and enjoyable drinking experience.

Moreover, ultrasound technology can assist in homogenizing the mixture, ensuring that all ingredients are evenly distributed throughout the liquid. This prevents separation, a common issue in blended beverages, where heavier particles settle at the bottom. The uniform texture and improved flavor retention achieved with ultrasound not only elevate the quality of the beverage but also make it more visually appealing. This innovative approach enhances the overall experience of consuming fresh, blended drinks and adds significant value to blending appliances equipped with this feature.

In some embodiments, the blade assembly further includes a flow guiding module 655.

The flow guiding module creates a liquid low in the internal cavity of the cup body in the operation mode.

A flow-guiding module within a blending apparatus plays a crucial role in optimizing the blending process by facilitating the movement of objects within the internal cavity. When designed as a rotating blade, the module not only cuts and blends the contents but also generates a dynamic flow within the cavity. This flow creates a circulation pattern that prevents ingredients from settling at the bottom or sticking to the sides, ensuring consistent exposure to the blades for thorough blending.

The rotating blade, acting as the flow-guiding module, generates a vortex or turbulence in the internal cavity. This movement effectively agitates the contents, drawing heavier or larger objects toward the center and pushing lighter particles outward. By constantly moving the ingredients, the blade reduces the chances of uneven blending or clumping. This design is particularly advantageous for blending tough materials, as the flow ensures that all objects are moved toward the cutting edges, increasing the overall efficiency and effectiveness of the process.

Furthermore, this flow-guiding design enhances user convenience by reducing the need for manual intervention, such as stirring or repositioning ingredients during blending. The continuous movement created by the rotating blade minimizes dead zones within the internal cavity, allowing for smoother operation and better results. This feature not only improves blending performance but also extends the versatility of the appliance, enabling it to handle a wider range of ingredients with ease.

Please refer to FIG. 1 to FIG. 3 for an explanation of this blender apparatus. The blender apparatus includes a cup body 1, a blade assembly 3 and a bottom cover 4. The cup body comprises a first port 11 and a second port 12 connected to its inner cavity; the first port is detachably connected to a cup cover 2; one end of the blade assembly is detachably connected to the second port; the bottom cover is detachably connected to the second port.

The blade assembly comprises an operation state and a storage state. In the operation state, one end of the blade assembly is sealed and connected to the second port, and the cup cover is connected to the first port. In the storage state, the blade assembly is placed into the inner cavity of the cup body through the first port, and the bottom cover is connected to the second port, while the cup cover is connected to the first port.

Specifically, in the operation state, the cup body is used to hold fruits, vegetables, and other ingredients, as well as water. The blade assembly is used to extract juice from the ingredients. The blade assembly forms a sealed connection with the cup body, and the cup cover seals the cup body to prevent juice and food residue from splashing out when the blade assembly rotates. The blade assembly can adopt common structures from existing technology. This embodiment does not limit the specific structure of the blade assembly as long as it can extract juice from ingredients.

It should be noted that the inner cavity space of the cup body must be larger than the space occupied by the blade assembly to ensure the blade assembly can be completely placed inside the inner cavity of the cup body.

After juicing is complete, clean the blade assembly, cup body inner cavity, and cup cover. For storage, insert the blade assembly into the inner cavity of the cup body through the first port, then use the cup cover to seal the first port and the bottom cover to seal the second port, completely sealing the inner cavity of the cup body.

Compared to existing technology, this blender apparatus provides a blade assembly with both operation and storage states. In the storage state, the blade assembly can be stored within the inner cavity of the cup body, not occupying additional space, making the blender apparatus compact when not in use, convenient for storage and carrying. Additionally, in the storage state, the bottom cover seals the second port and the cup cover seals the first port, completely sealing the cup body and preventing loss of the blade assembly.

In some embodiments, in the operation state, the bottom cover is further connected to another end of the blade assembly.

In the operation state, generally, the cup body is positioned above the blade assembly, meaning the first port faces upward and the second port faces downward, with the upper end of the blade assembly connected to the second port. Therefore, the aforementioned another end of the blade assembly refers to the lower end of the blade assembly.

Specifically, the bottom cover is detachably connected to the lower end of the blade assembly, meaning the bottom cover can be installed not only on the lower end of the blade assembly but also on the second port. It should be noted that the above definition of “upper” and “lower” positions only applies to the operation state.

In the operation state, the bottom cover installed on the lower end of the blade assembly serves to support the blade assembly and reduce vibration. Additionally, anti-slip patterns can be set on the lower surface of the bottom cover, and vibration-dampening pads can be set on the inner surface to further reduce vibration and noise of the blade assembly during operation.

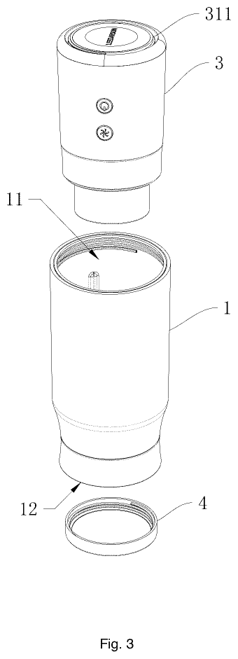

In some embodiments, the connections between the bottom cover and the blade assembly, and between the bottom cover and the second port can adopt the structure shown in FIG. 1 and FIG. 3. Referring to FIG. 1 and FIG. 3, the bottom cover and another end of the blade assembly, and the bottom cover and the second port are both threaded connections.

The threaded connection method makes the assembly and disassembly of the bottom cover with the blade assembly and second port convenient, making it easy for users to operate.

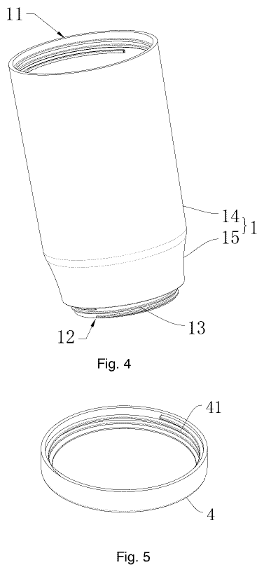

Preferably, referring to FIG. 3, FIG. 4, and FIG. 5, based on the above embodiment, the bottom cover comprises a first internal thread on its inner circumferential wall, another end of the blade assembly comprises a first external thread, the second port comprises a second external thread; wherein in the operation state, the first internal thread is connected to the first external thread; in the storage state, the first internal thread is connected to the second external thread.

Another end of the blade assembly comprises an annular groove on its end face, wherein the inner groove wall comprises the first external thread, the wall of the bottom cover can extend into the annular groove and seal it, achieving a threaded connection. In the operation state, most of the bottom cover extends into the annular groove, with only its end placed on the supporting surface (such as countertop, table surface, floor), and the end connects with the bottom surface of the blade assembly, which does not affect the overall appearance of the blender apparatus, nor does it additionally elevate the blade assembly, further reducing vibration of the blade assembly, and preventing loss of the bottom cover.

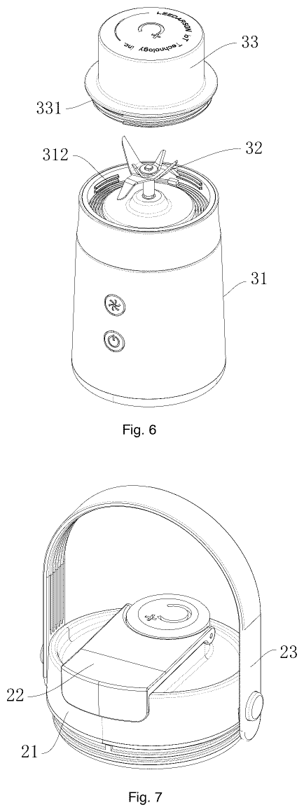

In some embodiments, the blade assembly can adopt the structure shown in FIG. 1 and FIG. 6. Referring to FIG. 1 and FIG. 6, the blade assembly comprises a blade base and a blade head. One end of the blade base is detachably connected to the second port; the blade head is rotatably mounted on the blade base, extends out of the blade base, and is positioned in the inner cavity of the cup body.

In the operation state, the blade base connects to the second port, the blade head extends into the cup body, and the blade head rotates to crush ingredients. It should be noted that the blade base comprises a power assembly inside, with the power output end connected to the rotation shaft of the blade head. The power assembly is a common power structure in existing technology, such as a motor. The power assembly can also connect to the rotation shaft of the blade head through a drive assembly. To prevent juice or food residue from entering the inside of the blade base, the blade head must form a sealed connection with the blade base.

Additionally, the surface of the blade base comprises a button group that can control the power assembly's on/off status and control the rotation speed of the power assembly. The above control method is common in existing technology and will not be elaborated here.

Referring to FIG. 1 and FIG. 6, based on the above embodiment, a blade base cover is detachably connected to one end of the blade base; wherein in the operation state, the blade base cover is separated from the blade base, in the storage state, the blade base cover is connected to the blade base. The blade base cover is used for blocking the blade head.

When the blender apparatus is not in use, whether the blade assembly is in storage state or placed outside the cup body, it is necessary to prevent human contact or touching of the blade head to avoid injury. With the blade base cover detachably connected to the blade base, when the blender apparatus is not in use, the blade base cover covers the outside of the blade head, completely shielding the blade head, thus preventing human contact or touching of the blade head.

Additionally, when the blender apparatus is in use, the blade base cover is separated from the blade base.

Referring to FIG. 4 and FIG. 6, based on the above embodiment, the blade base comprises a second internal thread on its inner wall at one end, the second port comprises a second external thread, the blade base cover comprises a third external thread on its outer wall; wherein in the operation state, the second internal thread connects to the second external thread; in the storage state, the second internal thread connects to the third external thread.

The blade base adopts threaded connections with both the second port and the blade base cover, making assembly and disassembly of the blade base with the cup body and blade base cover convenient and easy for users to operate, while also ensuring good sealing performance between the blade base and the second port to prevent juice and food residue from splashing out of the cup body. Additionally, the second external thread and third external thread achieve threaded connections through the second internal thread, which can simplify the end structure of the blade base.

In some embodiments, the cup body can adopt the structure shown in FIG. 4. Referring to FIG. 4, the cup body comprises a straight tubular portion and a conical tubular portion. One end of the straight tubular portion is the first port; the large diameter end of the conical tubular portion connects to another end of the straight tubular portion, wherein the inner diameter of the large diameter end equals the inner diameter of the straight tubular portion, the small diameter end is the second port; wherein the inner diameter of the straight tubular portion is greater than the outer diameter of the blade assembly.

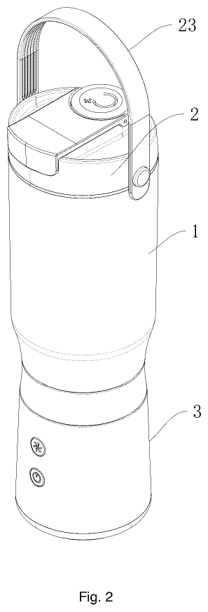

Since the cup body needs to connect with the blade assembly and accommodate the blade assembly, in the operation state, to ensure smooth transition between the outer surface of the cup body and the outer surface of the blade assembly for aesthetic purposes, one end of the cup body is designed with a narrowed opening, namely the conical tubular portion, to achieve smooth connection between the cup body and blade assembly, as shown in FIG. 2.

In some embodiments, the cup cover can adopt the structure shown in FIG. 7. Referring to FIG. 7, the cup cover comprises a main cover body and a flip cover. The main cover body is threadedly connected to the first port; the main cover body comprises a pouring port; one end of the flip cover is hinged to the main cover body, another end of the flip cover is snap-fitted with an outer wall of the main cover body; the flip cover is used for sealing the pouring port.

Whether in operation state or storage state, the main cover body is threadedly connected to the first port. The threaded connection makes assembly and disassembly of the main cover body with the cup body convenient and easy for users to operate. Only when placing ingredients into the cup body, removing food residue, cleaning the inner cavity of the cup body, or placing the blade assembly into or taking it out of the cup body is it necessary to separate the main cover body from the cup body.

The flip cover is hinged to the main cover body. After juicing is complete, there is no need to open the main cover body; just open the flip cover around its hinged end to access the juice inside the cup body through the pouring port.

Preferably, referring to FIG. 7, the cup cover comprises a handle rotatably connected to the cup cover. Installing the handle makes the blender apparatus convenient to hold and carry.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A blender apparatus, comprising:
a cup cover;
a bottom cover;
a cup body, wherein the cup body comprises an inner cavity, wherein the cup body comprises a first port above the inner cavity, wherein the cup body comprises a second port below the inner cavity, wherein the first port is detachably connected to the cup cover; and
a blade assembly, wherein the blade assembly comprises a blade and a motor and a blade housing, wherein the blade housing encloses the blade housing and exposes the blade, wherein a bottom end of the blade housing is attached to the bottom cover in an operation state, wherein the blade assembly comprises an operation state and a storage state, wherein in the operation state, the blade of the blade assembly is inserted into the inner cavity through the second port of the cup body for cutting and mixing objects placed in the inner cavity, wherein in the storage state, the blade of the blade assembly is inserted into the inner cavity through the first port of the cup body, wherein in the storage state, the bottom cover is connected to the second port of the cup body.

2. The blender apparatus of claim 1, wherein the blade is exposed on a top end of the blade housing, wherein the motor drives the blade to rotate inside the inner cavity of the cup body in the operation mode.

3. The blender apparatus of claim 2, wherein a connection between the bottom cover and the bottom end of the blade housing, and the connection between the bottom cover and the second port are both threaded connections.

4. The blender apparatus of claim 3, wherein the bottom cover comprises a first internal thread on an inner circumferential wall of the bottom cover, wherein the bottom end of the blade assembly comprises a first external thread, wherein the second port comprises a second external thread, wherein in the operation state, the first internal thread is connected to the first external thread, wherein in the storage state, the first internal thread is connected to the second external thread.

5. The blender apparatus of claim 1, wherein the cup body comprises a straight tubular portion and a conical tubular portion, wherein one end of the straight tubular portion is the first port, wherein a large diameter end of the conical tubular portion is connected to another end of the straight tubular portion, wherein an inner diameter of the large diameter end equals to an inner diameter of the straight tubular portion, wherein a small diameter end of the conical tubular portion is the second port, wherein the inner diameter of the straight tubular portion is greater than an outer diameter of the blade assembly.

6. The blender apparatus of claim 1, wherein the cup cover comprises a main cover body and a flip cover, wherein the main cover body is threadedly connected to the first port, wherein the main cover body comprises a pouring port, wherein one end of the flip cover is hinged to the main cover body, wherein another end of the flip cover is snap-fitted with an outer wall of the main cover body, wherein the flip cover is used for sealing the pouring port.

7. The blender apparatus of claim 1, wherein the cup cover comprises a handle rotatably connected to the cup cover.

8. The blender apparatus of claim 1, further comprising a safety switch, wherein when the top end of the blade housing is attached to the second port of the cup body, the safety switch activates the motor, wherein when the motor is not activated by the safety switch, the motor stops to work.

9. The blender apparatus of claim 1, further comprising a safety switch, wherein when the blade is inserted into the internal cavity, the safety switch is activated to deactivate the motor.

10. The blender apparatus of claim 1, wherein the blade assembly further comprises a blade cover, wherein the blade cover covers the blade, wherein the blade cover is detachable from the blade assembly.

11. The blender apparatus of claim 1, wherein an auxiliary blade is disposed on an opposite side of the blade housing with respect to the blade.

12. The blender apparatus of claim 11, wherein the blade or the auxiliary blade is selected to be inserted into the inner cavity of the cup body.

13. The blender apparatus of claim 1, wherein the blade assembly further comprising a heater for generating heat passed through the blade to the objects inside the inner cavity of the cup body.

14. The blender apparatus of claim 1, wherein the blade assembly further comprises a battery for supplying power to the motor.

15. The blender apparatus of claim 14, wherein the blade assembly further comprising a fan disposed on the opposite side of the blade housing, wherein the blade and the fan shares the motor.

16. The blender apparatus of claim 1, wherein the blade assembly further comprising an ultrasonic cleaner module, wherein the ultrasonic cleaner module cleans the internal cavity of the cup body when users load the internal cavity with clean water.

17. The blender apparatus of claim 16, wherein the ultrasonic cleaner module share the motor with the blade.

18. The blender apparatus of claim 17, where a vibrating unit of the ultrasonic cleaner module is mounted on the blade.

19. The blender apparatus of claim 16, wherein the ultrasound cleaner module is activated when the blade is cutting and blending the objects in an ultra blending mode.

20. The blender apparatus of claim 1, wherein the blade assembly further comprises a flow guiding module, wherein the flow guiding module creates a liquid low in the internal cavity of the cup body in the operation mode.
